(19) United States
(12) Patent Application Publication
(10) Pub. No.: US 2025/0086949 A1
(43) Pub. Date: Mar. 13, 2025

(54) SEMI-WEAKLY SUPERVISED OBJECT DETECTION USING PROGRESSIVE KNOWLEDGE TRANSFER AND PSEUDO-LABEL MINING

(71) Applicant: TELEFONAKTIEBOLAGET LM ERICSSON (PUBL), Stockholm (SE)

(72) Inventors: AKHIL MEETHAL, MONTREAL (CA); ZHONGWEN ZHU, SAINT-LAURENT (CA); FRANCISCO PERDIGON ROMERO, SAINT-LAURENT (CA); MARCO PEDERSOLI, VERDUN (CA); ERIC GRANGER, MONTREAL (CA)

(21) Appl. No.: 18/726,476

(22) PCT Filed: Jan. 20, 2022
(86) PCT No.: PCT/IB2022/050484

§ 371 Date: Jul. 3, 2024

(51) Int. Cl. G06V 10/778; G06V 10/22; G06V 10/82

(52) U.S. Cl. CPC G06V 10/778; G06V 10/22; G06V 10/82

(57) ABSTRACT

The disclosure relates to a method for training a machine learning (ML) model for image-based object detection. The method comprises obtaining the image, at least one image-class label identifying a class of object present in the image, and a plurality of indicators of candidate areas in the image. The method comprises the following steps executed iteratively. Computing a score, for each image-class label, for each of the plurality of indicators of candidate areas in the image. For each image-class label, selecting an indicator of a candidate area, based on the score associated with the indicator of the candidate area for the image-class label. Executing a training epoch of the ML model using the image as input and each image-class label and each corresponding selected indicator of the candidate area as labels for the image. Obtaining a predicted area for each image-class label.

### TECHNICAL FIELD

The present disclosure relates to object detection in weakly labeled images.

### BACKGROUND

Object detection is a fundamental image understanding task with many potential applications in various industries. Most of the successful detectors in use today come from deep neural networks trained with a large number of annotated images. An annotation consists of a bounding box and class label of each instance present in the image.

Obtaining dense annotations is a very time-consuming process and requires expert level knowledge in many applications like medical images. This limits the scalability of object detectors to various domains with less annotated datasets available since it is not feasible to annotate millions of images for every detection problem to solve.

In general, it is more practical to annotate a small set of images with dense annotations and supply the remaining images with coarse image level annotation or no annotations at all. This aligns with the process through which humans learn, building the knowledge from only very few labeled samples.

### SUMMARY

Deep machine learning (ML) based object detectors of the state of the art and used in practical applications are extremely data hungry as they need dense annotations of each object present in the image.

Although some large datasets are available to do the benchmark for training different general purpose object detection models, no such large datasets are available for domain specific problems, such as, as one example, the detection of radio units from different vendors mounted on a single large antenna tower. Large datasets are not generally available for each problem to solve, because it takes a lot of efforts to annotate the objects in data samples.

There is a need for solutions for training object detectors with low annotation costs.

One of the most promising solution, developed in recent years, in this direction is based on annotating a small set of images and providing the rest as a large pool of sparse image level annotations or no annotation at all. Most of the successful object detectors recently developed based on this premise are trained in a student-teacher learning fashion. The student-teacher learning has for drawback that if the teacher network model part is overfitted with a small, annotated dataset, the whole model leads to poor generalization.

The present disclosure presents a solution that addresses the overfitting problem due to multi-stage teacher-student architecture.

There is provided a method for training a machine learning (ML) model for image-based object detection. The method comprises, for each image of a plurality of weakly annotated images, obtaining the image, at least one image-class label identifying a class of object present in the image, and a plurality of indicators of candidate areas in the image. The method comprises, iteratively executing the following steps. Computing a score, for each image-class label, for each of the plurality of indicators of candidate areas in the image. For each image-class label, selecting an indicator of a candidate area, based on the score associated with the indicator of the candidate area for the image-class label. Executing a training epoch of the ML model using the image as input and each image-class label and each corresponding selected indicator of the candidate area as annotations for the image. Obtaining a predicted area for each image-class label.

There is provided an apparatus for training a machine learning (ML) model for image-based object detection. The apparatus comprises processing circuits and a memory, the memory containing instructions executable by the processing circuits whereby the apparatus is operative to, for each image of a plurality of weakly annotated images, obtain the image, at least one image-class label identifying a class of object present in the image, and a plurality of indicators of candidate areas in the image. The apparatus is operative to iteratively execute the following steps. Compute a score, for each image-class label, for each of the plurality of indicators of candidate areas in the image. For each image-class label, select an indicator of a candidate area, based on the score associated with the indicator of the candidate area for the image-class label. Execute a training epoch of the ML model using the image as input and each image-class label and each corresponding selected indicator of the candidate area as annotations for the image. Obtain a predicted area for each image-class label.

There is provided a non-transitory computer readable media having stored thereon instructions for training a machine learning (ML) model for image-based object detection. The instructions comprise obtaining the image, at least one image-class label identifying a class of object present in the image, and a plurality of indicators of candidate areas in the image. The instructions comprise iteratively executing the following steps. Computing a score, for each image-class label, for each of the plurality of indicators of candidate areas in the image. For each image-class label, selecting an indicator of a candidate area, based on the score associated with the indicator of the candidate area for the image-class label. Executing a training epoch of the ML model using the image as input and each image-class label and each corresponding selected indicator of the candidate area as annotations for the image. Obtaining a predicted area for each image-class label.

The method, apparatus and non-transitory computer readable media provided herein present improvements to the way object detection in weakly labeled images operate.

### BRIEF DESCRIPTION OF THE DRAWINGS

FIG. 1 is a schematic illustration of the proposed solution.

FIG. 2 illustrates, through a plurality of pictures, the evolution of the sampling process during learning.

FIG. 3 illustrates, through a plurality of pictures and corresponding heatmaps, sampler scores for different categories of objects.

FIG. 4 is a graph illustrating the change in performance as the percentage of bounding box annotations are increased.

FIG. 5 is a flowchart of a method for training a machine learning (ML) model for image-based object detection.

FIG. 6 is a schematic illustration of a hardware in which the steps described herein can be executed.

FIG. 7 is a schematic illustration of a virtualization environment in which the method(s) and apparatus(es) described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

Some related concepts are now introduced.

### Supervised Object Detection

Supervised object detection requires bounding box annotation for each instance present in the image. An “instance” in the context of this specification can be understood as meaning an object, a living thing, a person, or anything other which can be identified within an image. Supervised Object Detectors exist in two forms: two stage object detectors and one stage object detectors. Two stage object detectors have a first stage extracting Regions of Interest (RoIs), i.e., candidate object regions, where the reliability of a potential candidate region is quantified by an objectness score. Earlier approaches extract these RoIs using low-level image features in regions with convolutional neural networks (R-CNN), Fast R-CNN, etc. Alternatively, end-to-end two stage object detectors add an additional learnable head called Region Proposal Network (RPN) to extract these candidate regions. One stage object detectors, on the other hand, avoid the RoI extraction stage and classify and regress directly from anchor boxes. So, they are in general fast and applicable to real-time object detection. Though the two-step process makes the two stage detectors slower compared to their one stage counterparts, extracting reliable candidate region in the first stage brings an edge in terms of localization accuracy for these detectors. Recently, anchor free detectors are getting popular in the literature as these get away with the hand-designed anchor box selection and matching process, making the detectors even faster.

### Semi-Supervised/Weakly-Supervised Object Detection

Semi-supervised object detection takes a small set of labeled images and a large collection of unlabeled images to train a detector. This has been explored in many different forms. Detectors trained in a student-teacher fashion are gaining popularity. In this setting, a teacher model is trained first, using the available annotated set, and is then used to get pseudo-labels for unlabeled data. Once the pseudo-labels are obtained, a student model is trained using the combined dataset. Although the method presented herein also make use of the concepts of pseudo-labeling, the present approach is completely different from these methods, as there is no need for two separate networks and multiple stages of training, which makes it a much simpler solution for semi-supervised detection.

Some semi-supervised approaches use weak image-level labels, point annotations, etc. for the unlabeled images. Though this demands additional labeling effort, substantial improvements can be obtained for the amount of effort needed to get this supervision. The approach presented herein also makes use of weak image-level labels.

Weakly supervised detection on the other hand is using only image-level labels. However, weakly supervised methods are not able to distinguish an entire object from its parts and from its context. As a result, these detectors often produce bounding boxes on discriminative object parts, fail to distinguish the object boundaries when multiples objects of the same class are spatially adjacent and fail to produce precise localization for differentiating the object boundaries from its context.

The method presented herein is also learning from a vast majority of weak labels, but combined with a few fully annotated images, leading to better objectness distillation from the fully annotated images to weakly annotated. This is the most practical setting, as it is relatively easy to label a few handful samples with bounding box and supply the remaining with weak annotations or no annotations at all.

### Self-Training

Self-training is a popular idea in weakly and semi-supervised object detection. But these methods perform self-training with pseudo labels obtained offline, e.g.: training a Faster R-CNN network with detection result of weakly supervised detectors as pseudo labels. The method presented herein is doing self-training using the pseudo labels for weakly labeled images, but in an online fashion. In particular, there is a sampler, which for each iteration will sample pseudo Ground Truth (GT) boxes for each given weak label using the accumulated semantics from a score propagation block. Due to this online nature of the self-training, the training is a simple one stage process.

The solution presented herein provides the following advantages.

It is simple and effective in term of performance and accuracy compared to the existing multi-stage Semi-weakly Supervised Object Detection Models based on teacher-student architecture.

It also reduces the efforts to annotate objects present in the dataset (image) significantly.

The proposed solution is given in a generalized form and built on the standard fully supervised object detection model. Hence it can be easily adopted to handle any kind of object detection tasks required in different domains, including the support service in Telecom industry.

Herein, a simple semi-supervised learning paradigm for object detection using a small amount of fully annotated examples and a large set of weakly labeled images is proposed. The learning approach proposed herein is generic and can use any off-the-shelf fully supervised object detector as the backbone. In the below description, the Faster RCNN is used as the backbone detector, which is one example detector that can be used.

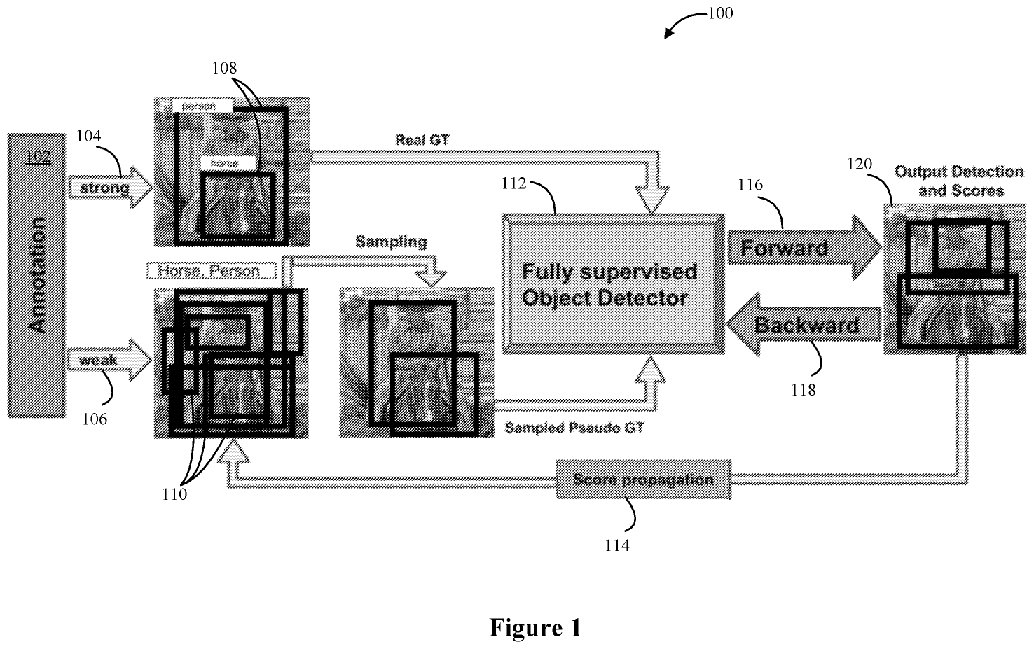

FIG. 1 illustrates the overall system 100 design. Depending on the available annotations 102 (strong 104 or weak 106), there are different routes for a learning step of the underlying backbone detector 112. In case of fully annotated images 104, real ground truth 108 (GT) boxes are available, so their learning is straightforward. In case of weakly annotated images 106, the pseudo GT boxes 110 are sampled using the sampler proposed herein (not illustrated) and scores are propagated from detection boxes back to object proposals using the score propagation block 114.

For every input image, depending on the available annotation type, forward 116 and backward 118 steps are performed after obtaining the (pseudo) GT boxes. Strong annotation is used to refer to images that are fully labeled and weak annotation is used to refer to images that are image-level labeled. For the fully labeled images, a normal forward-backward cycle is performed (the loss function being computed and the weights of the RCNN being updated during the backward pass) by taking the real GT annotations provided. For the weakly labeled images, a set of pseudo GT boxes are sampled for each class present in the image. Then, a forward step 116 is executed, and the detection scores are obtained 120. Scores are propagated back to the object proposals using the score propagation module 114.

Learning with Strongly Annotated Images

For the images that are strongly annotated, the learning step is very straightforward. The real GT regions provided for each instance present in the image are classified and regressed to. Let I be the input image with annotations t=(c₁, b₁), ⋅ ⋅ ⋅ (cₙ, bₙ) where each (cᵢ, bᵢ) denotes the bounding box class label and GT coordinates of an instance present in the image. Let C be the set of all possible classes. Then the multi-task loss function for fully labeled datapoints will be:

$${L}_{f} = \frac{1}{{N}_{cls}} {\sum }_{i} {L}_{cls} ( {p}_{i} , {c}_{i}^{*} ) + λ \frac{1}{{N}_{reg}} {\sum }_{i} {c}_{i}^{*} {L}_{reg} ( {b}_{i} , {b}_{i}^{*} ) \qquad ( 1 )$$

where L_{cls} and L_{reg} denote the classification and localization loss respectively. cᵢ*∈R^{C+1} is 1 for the ground-truth class label of the RoI and zero elsewhere, pᵢ ∈R^{C+1} is the predicted probability for that RoI. The dimension of these vectors is R^{C+1} accounting to the background class. bᵢ* is the ground-truth bounding box coordinate and bᵢ is the predicted bounding box coordinate. N_{cls} and N_{reg} are the normalization factors which depend on the number of foreground and background RoIs considered. A is a hyperparameter that controls the relative importance of the classification and localization loss. It should be noted that the exact form of Lf can vary according to the fully supervised detector architecture used in the model.
Learning with Weakly Annotated Images

When the image is weakly annotated, there is no real GT boxes. Object proposals (which correspond to boxes 110 of FIG. 1) are extracted using conventional techniques like selective search, edge box, etc. Although only less than a dozen boxes 110 are illustrated in FIG. 1, there can be hundreds or thousands of these boxes computed at this step. Generally, this computation is done only once, at the begin of the process and then the boxes are kept and used for each epoch (iteration) of the training. Then, pseudo GT boxes are computed using the proposed sampler 100. Then the same loss function that was computed as in equation (1) and the learning step can be performed. The sampling and score propagation process is a meta-learning on top of the detector learning which effectively guides the pseudo GT boxes to be selected from the most representative RoIs for the object. The proposals are sampled based on their accumulated classification score which is initialized to zero in the beginning and aggregated over the time during learning. The RoIs are evaluated during training, and then their classification score are propagated back to the set of proposals P in the image. During the course of learning, more scores will be accumulated near the regions corresponding to the object instances of the given class and hence the sampler will sample pseudo GT from those regions.

The sampling and score propagation processes are explained in detail below.

### Sampling Pseudo GT

For each object proposal p∈P there is a corresponding classification score for each class c. This score is accumulated via the score propagation step which is explained below. Let L be the set of all class present in the image as provided by the weak category (or class) labels. For each label l∈L, the scores of all proposals P for l, denoted by Sₗ are considered and one box is sampled based on the categorical distribution with logits as Sₗ. In practice, more than one box are sampled at a sampling stage in order to explore the sampling space faster.

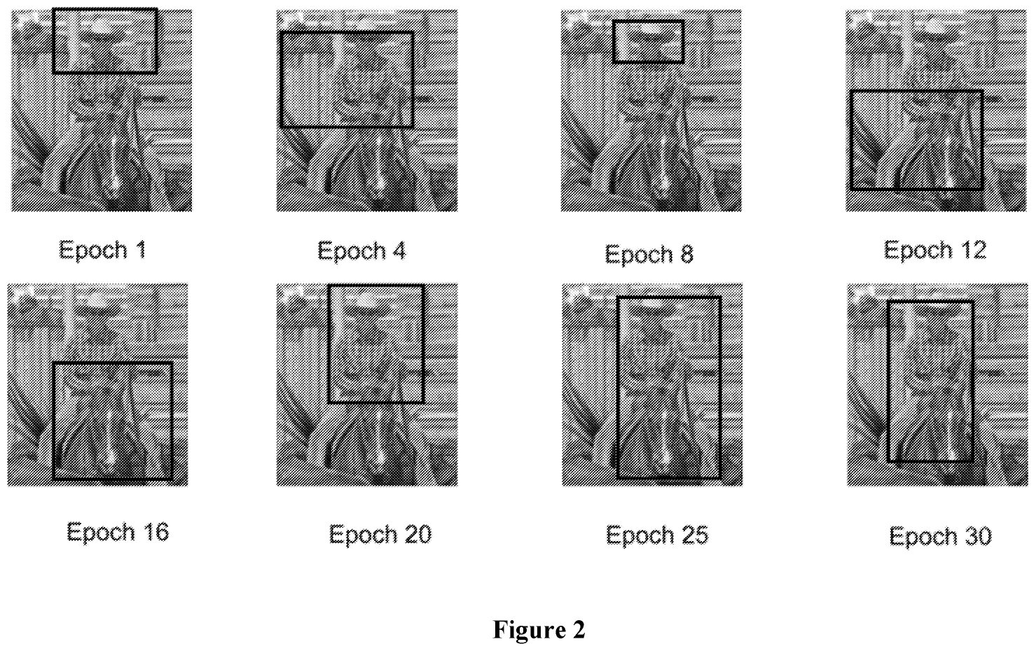

FIG. 2 illustrates an example sampling process for locating the “person” object present in the image. It can be observed in the images that, starting from a random location in the image at Epoch 1, the sampler is moving to a meaningful bounding box location for the “person” object with increasing epochs.

### Score Propagation

Score propagation is executed after the weights of the neural network are updated. The pseudo GT boxes are sampled from object proposals that are extracted using low-level image features such as super pixel straddling, maximally enclosing edge boxes, etc. These pseudo GT boxes have a score for each category of the object present in the dataset. The score is initialized uniformly in the beginning. Over the course of learning, the score propagation block 114 sends the semantics, which basically identifies a class label for the object proposal, of the detection boxes back to the proposals and information about the location of each category of the object present in the image is obtained. Score propagation is the component which assigns semantics to the object proposals. During learning, the proposals will accumulate scores from their overlapping RoIs produced by the detection box. In one embodiment the score propagation is according to the percentage of overlap between the proposal and RoI. This helps the proposals to aggregate the detection scores of their neighborhood region over the course of learning.

For each object proposal, scores from the maximum overlapping detection box are propagated to the object. A constraint can be set on the minimum overlap required to propagate scores which can be found empirically to be best when, for example, Intersection over Union (IoU) is 0.3. The formula used for score propagation is shown in equation (2):

$${S}_{c}^{p} = ( 1 - iou ) {S}_{c}^{p} + iou \cdot {S}_{c}^{d} . \qquad ( 2 )$$

where S_{c}^{p} is the score of category or class c of proposal p, S_{c}^{d} is the score of the maximum overlapping detection box d for category c. The overlap is computed between proposal p and set of all detection boxes D, and the maximum overlap iou is observed from the detection box d.

$$iou = {max}_{d ∈ D} I oU ( p , d ) \qquad ( 3 )$$

IoU is used as the criterion for score propagation, since the accumulated scores for a proposal using equation (2) will contain the belief of the score in the neighborhood of that proposal over the course of learning. Thus, even if a noisy score estimation is done in the beginning when the detector is learning, the overall score accumulated will reflect the true semantics of that region. The pseudo code for score propagation of a single image sample is provided in Algorithm 1.

### Algorithm 1: Score Propagation Algorithm

Input: set of all proposals P, image level categories (or labels) c, set of all detection boxes D
Ouput: updated scores for all proposals in P
For each image category or class c∈C
   For each proposal p∈P

$$iou = max iou ( p , d )$$

$${S}_{c}^{d} = {Score}_{c} ( arg max iou ( p , d ) )$$

$${S}_{c}^{p} = {Score}_{c} ( p )$$

$${S}_{c}^{p} = ( 1 - iou ) {S}_{c}^{p} + iou \cdot {S}_{c}^{d}$$

### Ratio of Strong Vs Weak Annotation

During learning, for each epoch, a significant number of noisy annotations can be observed vs correct annotations as fully annotated images are very limited in number.

While the fully supervised object detectors regress a bounding box with the right object size, for weakly supervised models it is difficult because there is no ground truth to regress to. So, in the settings used during learning, a large number of weakly labeled data having noisy pseudo GTs and a small fraction of correctly labeled data are fed to the model. Thus, in a training epoch, the model gets overwhelmed with a large chunk of noisy labels. This in turn affects the model generalization ability as it captures more of the noise than the actual concept during learning.

In the existing semi-supervised literature following the student-teacher paradigm, a teacher model is first trained only using the available real GT. This results in multiple stages of training and chances of overfitting the teacher model when trained on a small amount of data in the first stage.

To alleviate the difficulties of having a small sample of fully annotated images and to facilitate better learning under this setting, the available fully annotated images are oversampled such that the model processes a balanced amount of fully and weakly annotated images in every epoch. This is done by tuning a ratio parameter r that controls the amount of datapoints from the fully and weakly labeled pool of data. This has the advantage of not changing the internals of the underlying detector such as loss function or additional regularization etc. With this design, both the fully annotated and weakly annotated images can be fed parallelly to the model, which can be trained in a single stage. The number of datapoints to be sampled from both the pools can be estimated according to r. Then the images from the pool can be randomly sampled according to the estimated number. In practice setting a ratio above 0.5 gives good results.

### Experiments and Experimental Setup

Datasets and evaluation metric: the effectiveness of the proposed semi-supervised system was evaluated on the two popular benchmark datasets in Object Detection, Pascal VOC and MS-COCO. For Pascal VOC, the training was done using VOC 2007 trainval set as the fully labeled set and VOC 2012 trainval set as the weakly labeled set. VOC 2007 trainval set contains 5011 images and VOC 2012 trainval set contains 11540 images, thus roughly establishing a 1:2 ratio between fully annotated and weakly annotated dataset.

Ablation experiments were performed on VOC dataset with VOC 2007 trainval split into different percentages of fully annotated and weakly annotated sets. 0%, 5%, 10%, and 20% of the images with bounding box annotations were used in this study. The images were sampled randomly to create the fully annotated and weakly annotated split. For all experiments with VOC dataset, VOC 2007 test set was used for evaluation. The standard VOC average precision (AP) metric (AP 50) is used to measure the performance of the model. AP is computed using:

$$AP = \frac{1}{11} {\sum }_{r ∈ \{ 0 , 0.1 , … , 1 \}} {P}_{interp} ( r ) . \qquad ( 4 )$$

For MS-COCO, the trainval set was split into fully annotated and weakly annotated sets and the model was evaluated on its validation set. The fully annotated set used 5%, 10% and 20% of annotated images randomly selected from the trainval set and the remaining was used as the weakly annotated set. The standard MS-COCO AP (0.5:0.05:0.95) metric was used for performance measurement and comparison. In addition to that, the AP 50 and the VOC style AP were measured. MS-COCO trainval set consisted of 118 k training images and 5 k validation images.

### Implementation Details

VGG16 was used as the backbone network in most of the studies, which is pre-trained on the ImageNet dataset. The results are also reported for a ResNet50 backbone in the comparison to other methods. The backbone detector used is Faster R-CNN. The whole network was trained end-to-end using stochastic gradient descent (SGD) with a momentum of 0.5 and a weight decay of 0.0005. The initial learning rate was set to 1e−3 and decayed at epochs [5,10] by a factor of 10. The model was trained for 20 epochs. Though a single stage training can give good results, a slightly different two stage training approach was adopted for improving the results further. In particular, the layers of the feature extraction layers pre-trained on ImageNet were frozen and only the RCNN and RPN heads of the Faster RCNN we tuned in the first stage. In the second stage, the whole Faster RCNN model was initialized with the weights from the first stage training and all the layers were fine-tuned.

During training, the shorter edge of the input images was randomly rescaled to a scale in {480, 576, 688, 864, 1200}. Horizontal flipping was used as the only data augmentation. The object proposals were extracted using selective search algorithm. Typically, from an image, up to 2000 object proposals were extracted for good recall of all the object instances. However, this resulted in a large number of noisy proposals which overwhelmed the sampler, and it required many epochs to sample better pseudo GT boxes. So, class activation maps were extracted using gradCAM. Images were normalized with “mean”=[0.485, 0.456, 0.406] and “std”=[0.229, 0.224, 0.225] as in ImageNet training. The network was trained on NVIDIA V100 GPU with 32 GB memory.

### Ablation Study

Several ablation studies were conducted to assess the working of the components in the proposed model. First, the working of sampler and score propagation, and impact of different ways of defining them were studied. Then the impact of learning with more annotations was analyzed. Finally, the contribution of different types of errors in the mistakes the model is making was studied. All of these studies were conducted on PASCAL VOC 2007 by training the model using its trainval set and testing on its test set. 10% bounding annotations was used in this analysis.

### Sampler and Score Propagation

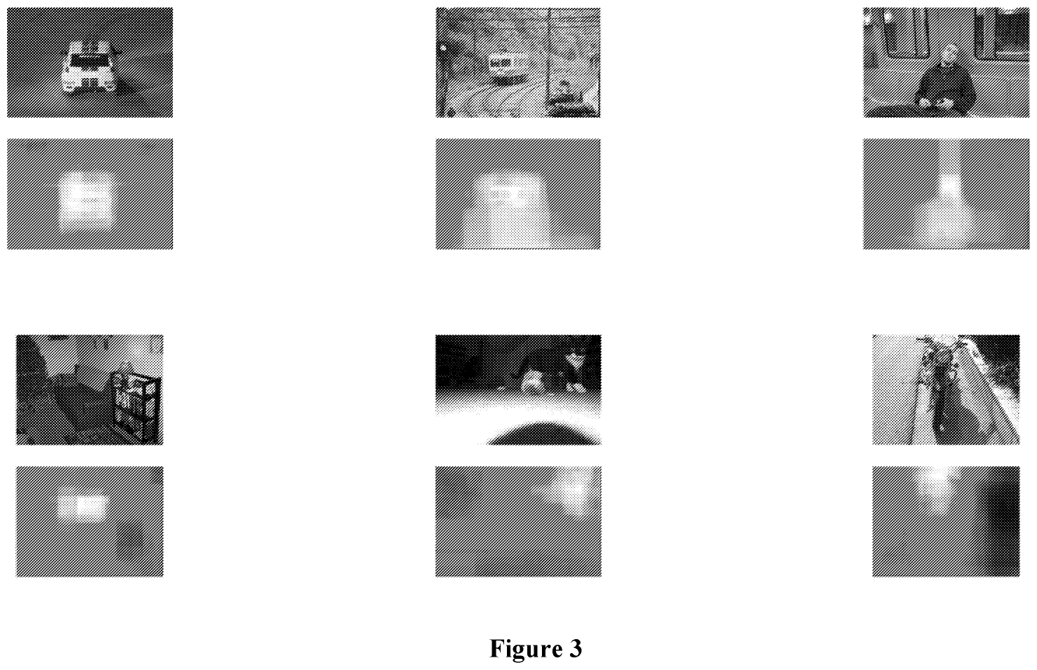

To understand whether the sampler is learning meaningful details about the object location, the heatmap produced by the score distributions of the object proposals was analyzed for each given class. To get the heatmap, for each pixel location, the scores from all object proposals covering that pixel were added and then normalized by the number of object proposals covering that pixel. FIG. 3 shows a set of heatmaps from this experiment. It can be observed that, the heatmaps correlates well with the location of the objects (the lighter the pixels, the stronger the correlation) and hence the sampler is getting meaningful semantic information through the sampling and score propagation process.

The score propagation can be designed in many ways. Scores could be propagated from all detection boxes, or from a selected set of detection boxes matching some quality criteria. Three settings were considered in the study: score propagation from all detection boxes, score propagation from the maximum overlapping detection boxes, score propagation from the maximum overlapping detection boxes when the overlap is above a threshold θ. The threshold θ was tuned and it was found that θ=0.3 gave best performance.

Table 1 summarizes the results from this study on the VOC2007 dataset. The Mean Average Precision metric (mAP) was used to assess the performance of the different proposed ensembles. mAP is computed with

$$mAP = \frac{1}{\vert C \vert} {\sum }_{c = 1}^{C} {AP}_{c} .$$

The model was trained using different 10% split on its trainval set and evaluated on the test set. It can be observed that, propagating scores from the maximum over-lapping detection box of each proposal works better. When the overlap is above a threshold θ, quality constraints are increased for score propagation and it improves the results. Score propagation from all detection boxes doesn't perform well, although it can provide a smoother update to the object proposal scores. It was hypothesized that the reason might be due to the distribution of the high scores over a large area when all detection boxes are propagating their scores; this result in wrong sampling of oversized proposals, especially for smaller objects.

| Score propagation strategy | mAP |
|---|---|
| Propagate from all boxes | 55.70 |
| Propagate from max-overlapping detection | 58.23 |
| boxes | |
| Propagate from max-overlapping detection | 60.32 |
| boxes when IOU > θ | |

Table 1. Score propagation strategies; propagate from all detection boxes, propagate from maximum overlapping detection boxes. The performance is measured on a semi-supervised model using 10% annotations and remaining weakly labeled images on VOC2007 dataset.

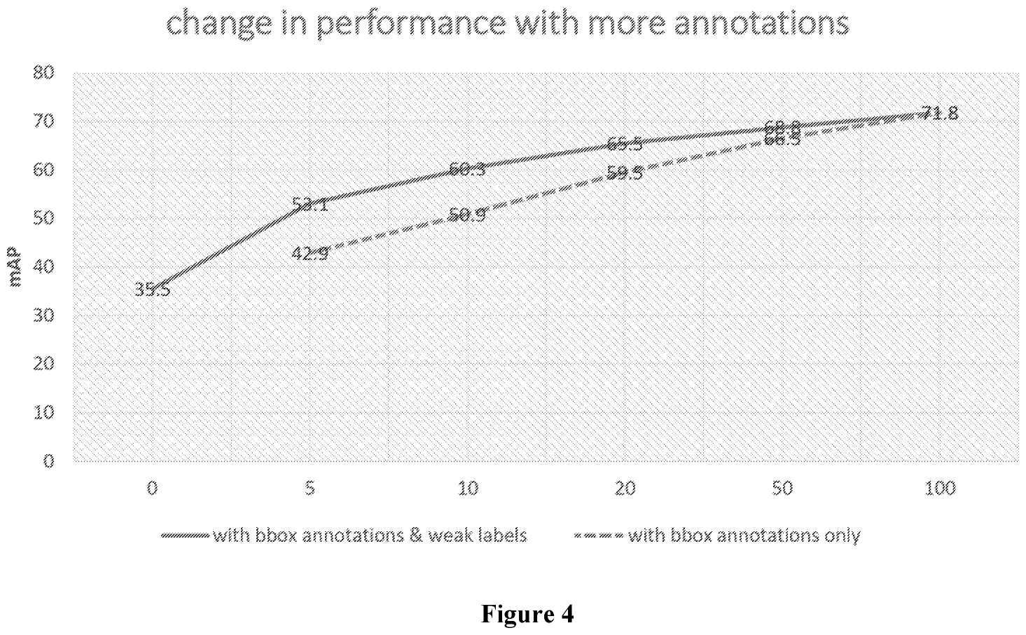

FIG. 4 illustrates the change in performance with more supervision, i.e. more annotated boxes. Impact of adding more fully annotated model can also be observed. The mAP reaches close to the performance of fully annotated case with a limited set of bounding box annotations.

### Impact of the Ratio Parameter

The importance of the ratio parameter for balancing the number of fully annotated and weakly annotated images was also studied. The results from this study are shown in table 2. It can be observed that, without this balancing, the performance of the detector is even worse than with the settings where only annotated images were used. With the ratio balancing, the performance of the model significantly surpasses fully supervised alone case. Thus, it can be concluded that, by tuning this ratio parameter, an effective strategy, for making use of the large pool of weakly annotated images, is obtained. One of the appealing properties of this method is that it doesn't need any change to the model architecture or loss function.

TABLE 2
Impact of the ratio of fully annotated
vs weakly annotated datapoints.

| Settings | mAP |
|---|---|
| Fully supervised training with 10% annotated | 45.50 |
| images alone | |
| Semi-supervised training with 10% full | 42.58 |
| annotations and remaining weak annotations | |
| (without ratio balancing) | |
| Semi-supervised training with 10% full | 60.32 |
| annotations and remaining weak annotations | |
| (with balancing) | |

### Impact of the Class Activation Map (CAM) Proposals

In this section, the impact of performance when object proposals overlapping the CAM of the relevant class is considered in the sampling stage is discussed. The CAM is obtained by training a vgg16 network on the multi-label VOC 2007 image-level labels. Then the overlap of Selective Search proposals to the CAM of all classes present in the image is computed. Based on the overlap, the object proposals with no overlap to the CAM, which is possibly from the background region of the image are ignored. This results in a slight loss of recall, but the improvement in terms of the mAP is good, especially when the number of fully annotated images are very less. In that case, the presence of large number of noisy proposals can misguide the sampler. Table 3 summarizes the results from this study. It is clear that filtering noisy proposals using CAM brings improvement in mAP. But the impact of the CAM proposals reduces with the availability of more fully annotated images. This is in accordance with the general facts that with more annotations, the appearance model will be more accurate and hence, the model itself will be powerful enough to distinguish the object boundaries very well.

TABLE 3
Impact of the ratio of fully annotated
vs weakly annotated datapoints.

| % images with | | |
|---|---|---|
| bounding box | mAP without CAM | mAP with CAM |
| annotation | proposals | proposals |
| 0% | 27.21 | 35.54 |
| 5% | 48.40 | 53.12 |
| 10% | 57.55 | 60.32 |
| 20% | 64.56 | 65.53 |

### Loss in Performance

The distribution of errors from the model was analyzed using the TIDE evaluation tool. The localization error contributed the most towards the overall mistakes that the model was making. This was expected as there is a large fraction of the images without bounding box labels, so the objectness distilled from a small fraction of fully annotated images isn't sufficient to capture large variations in appearance. Missed ground-truth was the next major error of the model, and this was mainly the consequence of exploration capacity of the sampler. Once some major object regions start getting higher scores from the score propagation, the model can miss other difficult instances, especially the smaller objects. Thus, the sampler won't sample candidate proposals from those regions which remain undetected. Frequently co-occurring background regions can also affect the results. Those regions also get sampled many times, resulting in detection boxes at background regions.

### Comparison with State-of-the-Art Methods

Comparison in mAPs was done for different methods on VOC 2007 test set and is shown in Table 4. The model was trained using VOC 2007 as fully annotated set and VOC 2012 as the weakly annotated set. The VOC style mAP is reported.

TABLE 4
Comparison with state-of-the-art methods

| | | |
|---|---|---|
| Method | Baseline | mAP |

Semi-supervised

| | | |
|---|---|---|
| CSD | 73.9 | 76.7 |
| STAC | 76.3 | 77.4 |
| Humble teacher | 76.3 | 80.9 |

Semi-weakly supervised

| | | |
|---|---|---|
| WSSOD | 73.1 | 78.9 |
| Method presented herein | 73.4 | 78.6 |

### Example Application

The detector proposed herein is generic by nature, so it can be adapted to any real-world object detection problem. Further performance comparison between the proposed solution with existing solutions, have been carried out, using common datasets which are widely available and used for benchmarking in the field of object detection research. Those datasets consist of images taken from the real world using mobile phone or professional cameras. The object to be detected includes a person, horse, bicycle, car, etc. Hence it is expected that the proposed detector can be applied to different use cases that are encountered in real life, such as surveillance in nursing house, radio tower inspection, checking-out and monitoring service in retail store, security home surveillance, autonomous driving, etc. The techniques described herein can also be used in artificial/virtual reality (AR/VR) under the concept of metaverse.

Radio tower inspection for the telecom industry is discussed hereafter to demonstrate how the proposed solution can be used.

A radio tower is one of the important elements in mobile networks. Normally, it has several radio access units installed, such as radio antenna, baseband unit, etc. Due to weather conditions, the performance of these devices might deteriorate significantly against time. For instance, a strong wind vibrates the radio tower, which loses the connection between devices (antenna) and a radio tower. The current device position can deviate from the original position configured at the installation. This leads to unexpected radio interference that reduce the capacity of data transmission.

Hence, in order to keep those devices on the radio tower perform according to the design, an operation and maintenance team is sent to do routine inspection regularly. With the evolution of drone technology, now the team can fly a drone to do the inspection instead of climbing up to do the measurement.

With the video captured by the drone, the team spends the time to look at each frame, identify all the objects on the tower, and make a judgement call to see if the installation of the targeted device is still within the designed range for the accepted performance or not. It should be noted that each object is associated to a device, and each device has its own functions as well as manufacturer. As one example, on a single radio tower, there can be three antennas from company 1, two antennas from company 2, two baseband units from company 1 and one baseband unit from company 2. Each of these devices is a potential object of interest that should be detected from the images for the inspection and further investigation.

To achieve object detection, an object detection model is needed. Ideally, to build this kind of object detection model, thousands of annotated images would be needed.

On the other hand, since the annotation requires the involvement from human beings, this manual involvement brings down any motivation of building such kind of object detection model, if a fully annotated dataset is required.

The solution proposed herein mitigates the problem mentioned above significantly since it only requires a small amount or percentage of the dataset to be annotated. With the solution proposed herein a model can be built to have the accepted accuracy for object detection without a big effort of manual annotation.

The image data required for this task can be captured using drone cameras flying around the Radio tower. Then the object detection can be performed either on some keyframes of the video sequence or on the entire video (all the frames).

For real-time detection on video streams, fast one stage object detectors like YOLO, SSD can be trained using the proposed technique. This only requires replacing the backbone fully supervised detector using YOLO or SSD in the proposed solution architecture.

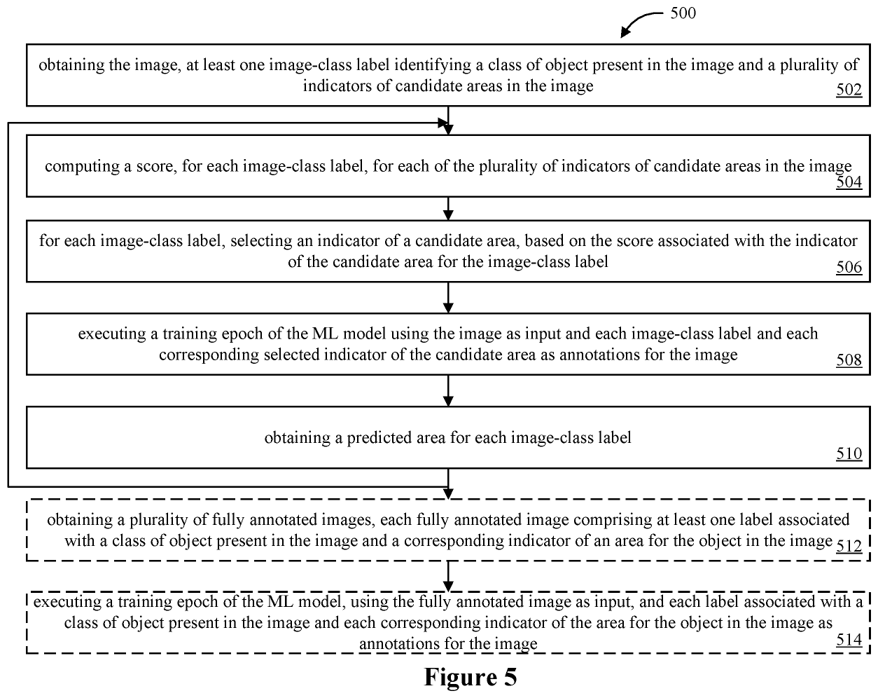

Let's now turn to FIG. 5, which illustrates a method 500 for training a machine learning (ML) model for image-based object detection. The method 500 comprises, for each image of a plurality of weakly annotated images, obtaining the image, step 502, at least one image-class label identifying a class of object present in the image, and a plurality of indicators of candidate areas in the image. The method comprises iteratively executing the following steps. Computing, step 504, a score, for each image-class label, for each of the plurality of indicators of candidate areas in the image. For each image-class label, selecting, step 506, an indicator of a candidate area, based on the score associated with the indicator of the candidate area for the image-class label. Executing, step 508, a training epoch of the ML model using the image as input and each image-class label and each corresponding selected indicator of the candidate area as annotations for the image. Obtaining, step 510, a predicted area for each image-class label.

For each of the plurality of images, the at least one image-class label may be predetermined based on: a user defined annotation, or metadata associated with the image. Metadata may include information such as a date and hour, a geographical location where the image was taken, etc.

The plurality of indicators of candidate areas may be computed using an object detection technique. Object detection techniques include techniques know to a person skilled in the art, including, for example, selective search, enclosing edge box, super pixel straddling, etc.

Computing the score for each image-class label, for each of the plurality of indicators of candidate areas in the image, may comprise setting the score to zero, for each of the plurality of indicators of candidate areas in the image, before a first training epoch. In alternative embodiments, it is possible that the score could be set to a value different than zero, as would be apparent to a person skilled in the art.

Computing the score for each image-class label, for each of the plurality of indicators of candidate areas in the image may comprise computing a percentage of overlap area between each of the plurality of indicators of candidate areas in the image and the predicted area, for each image-class label, and updating the score of each of the plurality of indicators of candidate areas in the image according to the percentage of overlap area.

The score, denoted SP, where c is the image-class label and p is the predicted area, may be computed using: S_{c}^{p}=(1−iou)S_{c}^{p}+iou·S_{c}^{d}, where S_{c}^{d} is a score of a maximum overlapping detection box d for c and iou, the intersection over union, is computed using iou=max_{d∈D}I oU(p, d), where D corresponds to the plurality of indicators of candidate areas in the image and d corresponds to one indicator of a candidate area. The score could be computed using other formulas as would be apparent to a person skilled in the art.

Selecting the indicator of a candidate area, based on the score associated with the indicator of the candidate area may comprise selecting the indicator of a candidate area, for each image-class label, via score based proportional sampling, wherein a higher score has a higher probability of begin selected; the probability being updated at each training epoch. For example, if s={s_1, s_2, . . . s_N} are the scores, these score can be normalized with a softmax to become probabilities and these probabilities can be used to sample the candidate areas from a multinomial distribution.

The method may further comprise obtaining, step 512, a plurality of fully annotated images, each fully annotated image comprising at least one label associated with a class of object present in the image and a corresponding indicator of an area for the object in the image; and executing, step 514, a training epoch of the ML model, using the fully annotated image as input, and each label associated with a class of object present in the image and each corresponding indicator of the area for the object in the image as annotations for the image.

The ML model may be selected among one stage object detectors or two stage detectors using deep neural networks. These detectors would be known to a person skilled in the art and could be used interchangeably. The ML model may be a faster region convolutional neural network (F-RCNN). Executing a training epoch of the ML model may comprise updating weights of the F-RCNN.

The number of fully annotated images may be increased using a data augmentation technique. Data augmentation techniques are known to a person skilled in the art.

The indicator of a candidate area may be a set of coordinates defining a rectangular area, coordinates of a point and a length and width defining a rectangular area, or coordinates of a point and a radius defining a circular area, or any other suitable indicator as would be apparent to a person skilled in the art.

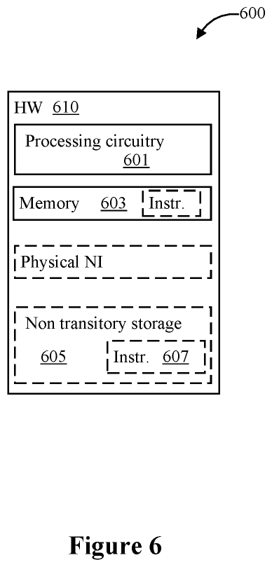

Referring to FIG. 6, there is provided hardware (HW) 610 that can take the form of an apparatus, server, network node, device, computer, smart phone, tablet, drone, vehicle, internet of things device, etc. The apparatus 610 comprises processing circuitry 601, a memory 603 which may comprise instructions. The apparatus may comprise physical network interface(s) and non-transitory storage 605 which may be local or remotely accessed, and which stores instructions 607 for executing by the processing circuitry 601. The hardware may also include a power source. It will be recognized that such hardware is well known to a person skilled in the art, may comprise many more components, and does not need to be described in further details.

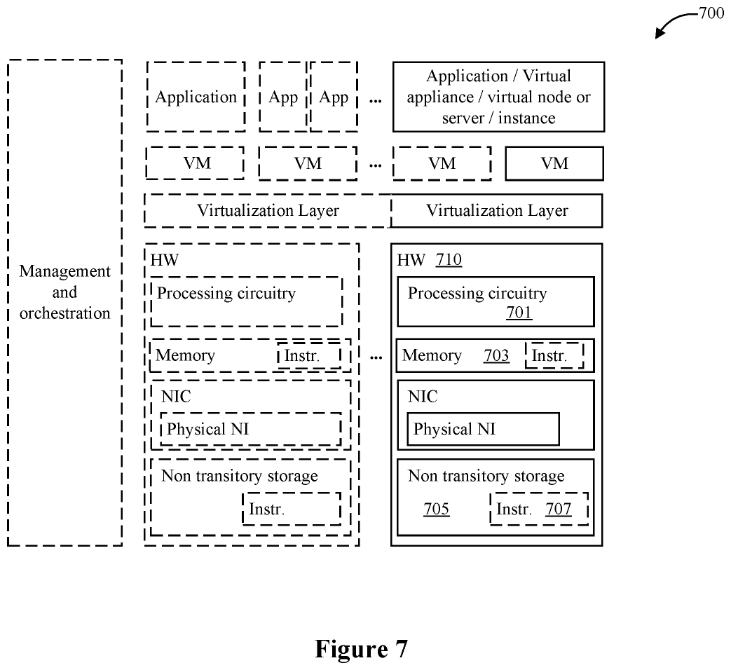

Referring to FIG. 7, there is provided a virtualization environment in which functions and steps described herein can be implemented.

A virtualization environment (which may go beyond what is illustrated in FIG. 7), may comprise systems, networks, servers, nodes, devices, which can all be represented by HW 710, etc., that are in communication with each other either through wire or wirelessly, e.g. through a network interface component (NIC). Some or all of the functions and steps described herein may be implemented as one or more virtual components (e.g., via one or more applications, components, functions, virtual machines or containers, etc.) executing on one or more physical apparatus in one or more networks, systems, environment, etc.

A virtualization environment provides hardware 710 comprising processing circuitry 701 and memory 703. The memory can contain instructions executable by the processing circuitry whereby functions and steps described herein may be executed to provide any of the relevant features and benefits disclosed herein.

The hardware 710 may also include non-transitory, persistent, machine readable storage media 705 having stored therein software and/or instruction 707 executable by processing circuitry to execute functions and steps described herein.

The instructions 707 may include a computer program for configuring the processing circuitry 701. The computer program may be stored in a removable memory, such as a portable compact disc, portable digital video disc, or other removable media. The computer program may also be embodied in a carrier such as an electronic signal, optical signal, radio signal, or computer readable storage medium.

There is provided an apparatus 610, 710 for training a machine learning (ML) model for image-based object detection. The apparatus comprises processing circuits 601, 701 and a memory 603, 703. The memory contains instructions executable by the processing circuits whereby the apparatus is operative to, for each image of a plurality of weakly annotated images, obtain the image, at least one image-class label identifying a class of object present in the image, and a plurality of indicators of candidate areas in the image. The apparatus is operative, iteratively, to execute the following operations. Compute a score, for each image-class label, for each of the plurality of indicators of candidate areas in the image. For each image-class label, select an indicator of a candidate area, based on the score associated with the indicator of the candidate area for the image-class label. Execute a training epoch of the ML model using the image as input and each image-class label and each corresponding selected indicator of the candidate area as annotations for the image. Obtain a predicted area for each image-class label.

For each of the plurality of images, the at least one image-class label is predetermined based on: a user defined annotation, or metadata associated with the image. The apparatus is further operative to compute the plurality of indicators of candidate areas using an object detection technique.

The apparatus is further operative, when computing the score for each image-class label, for each of the plurality of indicators of candidate areas in the image, to set the score to zero, for each of the plurality of indicators of candidate areas in the image, before a first training epoch.

The apparatus is further operative, when computing the score for each image-class label, for each of the plurality of indicators of candidate areas in the image, to compute a percentage of overlap area between each of the plurality of indicators of candidate areas in the image and the predicted area, for each image-class label, and updating the score of each of the plurality of indicators of candidate areas in the image according to the percentage of overlap area.

The apparatus is further operative to compute the score, denoted S_{c}^{p}, where c is the image-class label and p is the predicted area, using: S_{c}^{p}=(1−iou)S_{c}^{p}+iou·S_{c}^{d}, where S_{c}^{d} is a score of a maximum overlapping detection box d for c and iou, the intersection over union, is computed using iou=max_{d∈D}I oU(p, d), where D) corresponds to the plurality of indicators of candidate areas dED in the image and d corresponds to one indicator of a candidate area.

The apparatus is further operative, when selecting the indicator of a candidate area, based on the score associated with the indicator of the candidate area, to select the indicator of a candidate area, for each image-class label, via score based proportional sampling, wherein a higher score has a higher probability of begin selected; the probability being updated at each training epoch.

The apparatus is further operative to obtain a plurality of fully annotated images, each fully annotated image comprising at least one label associated with a class of object present in the image and a corresponding indicator of an area for the object in the image; and execute a training epoch of the ML model, using the fully annotated image as input, and each label associated with a class of object present in the image and each corresponding indicator of the area for the object in the image as annotations for the image.

The ML model may be selected among one stage object detectors or two stage detectors using deep neural networks. The ML model may be a faster region convolutional neural network (F-RCNN). The apparatus is further operative, when executing a training epoch of the ML model, to update weights of the F-RCNN.

The number of fully annotated images may be increased using a data augmentation technique.

The indicator of a candidate area may be a set of coordinates defining a rectangular area, coordinates of a point and a length and width defining a rectangular area, or coordinates of a point and a radius defining a circular area.

There is provided a non-transitory computer readable media 605, 705 having stored thereon instructions 607, 707 for training a machine learning (ML) model for image-based object detection. The instructions comprise obtaining the image, at least one image-class label identifying a class of object present in the image, and a plurality of indicators of candidate areas in the image. The instructions comprise iteratively executing the following steps. Computing a score, for each image-class label, for each of the plurality of indicators of candidate areas in the image. For each image-class label, selecting an indicator of a candidate area, based on the score associated with the indicator of the candidate area for the image-class label. Executing a training epoch of the ML model using the image as input and each image-class label and each corresponding selected indicator of the candidate area as annotations for the image. Obtaining a predicted area for each image-class label.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method for training a machine learning (ML) model for image-based object detection, comprising, for each image of a plurality of weakly annotated images:
obtaining the image, at least one image-class label identifying a class of object present in the image, and a plurality of indicators of candidate areas in the image;
iteratively:
computing a score, for each image-class label, for each of the plurality of indicators of candidate areas in the image;
for each image-class label, selecting an indicator of a candidate area, based on the score associated with the indicator of the candidate area for the image-class label;
executing a training epoch of the ML model using the image as input and each image-class label and each corresponding selected indicator of the candidate area as annotations for the image; and
obtaining a predicted area for each image-class label.

2. The method of claim 1, wherein, for each of the plurality of images, the at least one image-class label is predetermined based on: a user defined annotation, or metadata associated with the image.

3. The method of claim 1, wherein the plurality of indicators of candidate areas are computed using an object detection technique.

4. The method of claim 1, wherein computing the score for each image-class label, for each of the plurality of indicators of candidate areas in the image, comprises setting the score to zero, for each of the plurality of indicators of candidate areas in the image, before a first training epoch.

5. The method of claim 1, wherein computing the score for each image-class label, for each of the plurality of indicators of candidate areas in the image comprises computing a percentage of overlap area between each of the plurality of indicators of candidate areas in the image and the predicted area, for each image-class label, and updating the score of each of the plurality of indicators of candidate areas in the image according to the percentage of overlap area.

6. The method of claim 5, wherein the score, denoted S_{c}^{p}, where c is the image-class label and p is the predicted area, is computed using: S_{c}^{p}=(1−iou)S_{c}^{p}+iou·S_{c}^{d}, where Se is a score of a maximum overlapping detection box d for c and iou, the intersection over union, is computed using iou=max_{d∈D}I oU(p, d), where D corresponds to the plurality of indicators of candidate areas in the image and d corresponds to one indicator of a candidate area.

7. The method of claim 1, wherein selecting the indicator of a candidate area, based on the score associated with the indicator of the candidate area comprises selecting the indicator of a candidate area, for each image-class label, via score based proportional sampling, wherein a higher score has a higher probability of begin selected; the probability being a function of the scores updated at each training epoch.

8. The method of claim 1, further comprising:
obtaining a plurality of fully annotated images, each fully annotated image comprising at least one label associated with a class of object present in the image and a corresponding indicator of an area for the object in the image; and
executing a training epoch of the ML model, using the fully annotated image as input, and each label associated with a class of object present in the image and each corresponding indicator of the area for the object in the image as annotations for the image.

9. The method of claim 1, wherein the ML model is selected among one stage object detectors or two stage detectors using deep neural networks.

10. The method of claim 1, wherein the ML model is a faster region convolutional neural network (F-RCNN) and wherein executing a training epoch of the ML model comprises updating weights of the F-RCNN.

11. (canceled)

12. (canceled)

13. The method of claim 1, wherein the indicator of a candidate area is a set of coordinates defining a rectangular area, coordinates of a point and a length and width defining a rectangular area, or coordinates of a point and a radius defining a circular area.

14. An apparatus for training a machine learning (ML) model for image-based object detection comprising processing circuits and a memory, the memory containing instructions executable by the processing circuits whereby the apparatus is operative to, for each image of a plurality of weakly annotated images:
obtain the image, at least one image-class label identifying a class of object present in the image, and a plurality of indicators of candidate areas in the image;
iteratively:
compute a score, for each image-class label, for each of the plurality of indicators of candidate areas in the image;
for each image-class label, select an indicator of a candidate area, based on the score associated with the indicator of the candidate area for the image-class label; and
execute a training epoch of the ML model using the image as input and each image-class label and each corresponding selected indicator of the candidate area as labels for the image; and
obtain a predicted area for each image-class label.

15. The apparatus of claim 14, wherein, for each of the plurality of images, the at least one image-class label is predetermined based on: a user defined annotation, or metadata associated with the image.

16. The apparatus of claim 14, further operative to compute the plurality of indicators of candidate areas using an object detection technique.

17. The apparatus of claim 14, further operative, when computing the score for each image-class label, for each of the plurality of indicators of candidate areas in the image, to set the score to zero, for each of the plurality of indicators of candidate areas in the image, before a first training epoch.

18. The apparatus of claim 14, further operative, when computing the score for each image-class label, for each of the plurality of indicators of candidate areas in the image, to compute a percentage of overlap area between each of the plurality of indicators of candidate areas in the image and the predicted area, for each image-class label, and updating the score of each of the plurality of indicators of candidate areas in the image according to the percentage of overlap area.

19. The apparatus of claim 18, further operative to compute the score, denoted S_{c}^{p}, where c is the image-class label and p is the predicted area, using: S_{c}^{p}=(1−iou) S_{c}^{p}+iou·S_{c}^{d}, where S_{c}^{d} is a score of a maximum overlapping detection box d for c and iou, the intersection over union, is computed using iou=max_{d∈D}I oU(p, d), where D corresponds to the plurality of indicators of candidate areas in the image and d corresponds to one indicator of a candidate area.

20. The apparatus of claim 14, further operative, when selecting the indicator of a candidate area, based on the score associated with the indicator of the candidate area, to select the indicator of a candidate area, for each image-class label, via score based proportional sampling, wherein a higher score has a higher probability of begin selected; the probability being a function of the scores updated at each training epoch.

21. The apparatus of claim 14, further operative to:
obtain a plurality of fully annotated images, each fully annotated image comprising at least one label associated with a class of object present in the image and a corresponding indicator of an area for the object in the image; and
execute a training epoch of the ML model, using the fully annotated image as input, and each label associated with a class of object present in the image and each corresponding indicator of the area for the object in the image as annotations for the image.

22. The apparatus of claim 14, wherein the ML model is selected among one stage object detectors or two stage detectors using deep neural networks.

23. The apparatus of claim 14, wherein the ML model is a faster region convolutional neural network (F-RCNN), and is further operative, when executing a training epoch of the ML model, to update weights of the F-RCNN.

24. (canceled)

25. (canceled)

26. The apparatus of claim 14, wherein the indicator of a candidate area is a set of coordinates defining a rectangular area, coordinates of a point and a length and width defining a rectangular area, or coordinates of a point and a radius defining a circular area.

27. A non-transitory computer readable media having stored thereon instructions for training a machine learning (ML) model for image-based object detection, the instructions comprising:
obtaining the image, at least one image-class label identifying a class of object present in the image, and a plurality of indicators of candidate areas in the image;
iteratively:
computing a score, for each image-class label, for each of the plurality of indicators of candidate areas in the image;
for each image-class label, selecting an indicator of a candidate area, based on the score associated with the indicator of the candidate area for the image-class label;
executing a training epoch of the ML model using the image as input and each image-class label and each corresponding selected indicator of the candidate area as labels for the image; and
obtaining a predicted area for each image-class label.
